(19) United States
(12) Patent Application Publication
(10) Pub. No.: US 2008/0216611 A1
(43) Pub. Date: Sep. 11, 2008

(54) REMOVABLE THUMB SOCKET FOR LOOSENING AND TIGHTENING COAXIAL CABLE NUT

(76) Inventor: Eric Shawn Resnick, Simi Valley, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/038,685

(22) Filed: Feb. 27, 2008

Related U.S. Application Data
(60) Provisional application No. 60/893,255, filed on Mar. 6, 2007.

(51) Int. Cl. B25B 13/00

(52) U.S. Cl. 81/124.2

(57) ABSTRACT

A thumb socket for a multi-faceted coaxial cable nut includes a multi-faceted body. An exterior wall of the body defines a plurality of extended points in spaced radial relation, so as to form finger holds therebetween. An inner wall of the body defines a central cavity having a shape complimentary to at least a portion of an exterior of the coaxial cable nut. A notch is formed in the body having a diameter less than a diameter of the coaxial cable nut so as to forcibly receive the coaxial cable nut within the central cavity of the body to permit manual torque via the finger holds of the body to loosen or tighten the coaxial cable nut.

### BACKGROUND OF THE INVENTION

The present invention generally relates to audio visual cable connectors. More particularly, the present invention relates to a thumb socket adapter for a coaxial connector, sometimes referred to as an F-connector.

The vast majority of households have televisions. Broadcast signals are often times received by means of cable, satellite or antenna. Moreover, many households include additional electronic devices, such as DVD players, a VCR, surround sound system, etc.

Typically, the television is connected to the antenna, cable set top box, or satellite set top box with a coaxial cable. Moreover, often times the accessory electronic devices (DVD, VCR, etc.) are connected to the TV or one another with coaxial cables. Coaxial cables are electrical cables consisting of a round conducting wire, surrounded by an insulating spacer, and a cylindrical conducting sheet, usually surrounded by a final insulating wire. It is used as a high-frequency transmission line to carry high-frequency or broadcast signals. Because the electromagnetic fields carrying the signal exist only in the space between the inner and outer conductors, they typically cannot interfere with or suffer interference from external electromagnetic fields, and thus is particularly adapted for such audio visual systems.

The majority of connections between the coaxial cable and the television or other electrical accessory items are by means of an F-connector. Televisions typically have one or more female externally threaded plug sockets with a central wire receiving aperture. The other electrical devices, such as the VCR, DVD player, etc. also typically have such connector plugs. A male F-connector is attached to the end of the coaxial cable and includes an internally threaded ring configured to be threaded onto the external threads of the corresponding female plug of the electrical device. A hex nut is formed, or fastened to, the outer surface of the rotatable ring so as to provide a thumb screw mechanism for rotating and connecting the F-connector to the female plug. Typically, the central wire or cable of the coaxial cable is inserted into the central aperture of the plug, and the ring of the F-connector is rotated in a clockwise direction so as to secure the end of the cable to the plug and electrical device so that the signal is properly transmitted.

Typically, the threaded female plugs extend from the rear of the television, VCR, DVD player, etc. Often times, one connecting the coaxial cable to the electronic device must do so “blind”, that is by reaching around the electrical device and using his sense of touch to make the connection. This is often difficult, even when the female plug is viewable, due to the fact that the exterior hex nut on the F-connector ring is quite small. Thus, it can be difficult to get a firm grasp on the hex ring and twist it properly.

Several devices have been created or devised in the past to address this problem. For example, U.S. Pat. No. 5,067,750 to Minneman and U.S. Pat. No. 5,297,458 to Smith et al. disclose coaxial cable screw connector attachments or torque wrenches. These are inserted over an end of the coaxial cable F-connector, so as to engage the connector hexagonal nut. Both also include wings extending therefrom so as to aid the user in grasping and turning the device, and thus the hex nut and ring of the F-connector. However, both of these attachment devices require that the device be inserted onto the F-connector from the end thereof. There is no provision for inserting the device from the side of the hexagonal nut of the F-connector so as to loosen an F-connector to a female plug.

U.S. Patent Publication No. US 2004/0194585, to Clark, discloses a coaxial cable thumb socket. This device includes a slot which is adapted to be fit over the coaxial cable, and then moved upwardly onto the nut. Thus, Clark cannot be seated upon the hex nut directly. Moreover, Clark does not provide any outer grip assembly, in the form of wings, finger holds, or the like, and thus its utility is in question as compared to the hexagonal facets of the hex nut itself. U.S. Pat. No. 6,817,272 to Holland discloses a similar device, wherein a slit or notch is formed in the device which is adapted to be slipped over the coaxial cable itself, and then the device moved into engagement with the ring and hex nut. Once again, direct attachment to the hexagonal nut of the F-connector is not possible. Moreover, Holland does not disclose any finger holds, wings or the like to improve the grip, other than an enlarged size. U.S. Pat. No. 6,938,522 to Stannik discloses yet another device which is similar to those described above, wherein a passageway is provided for the device to be slipped over the coaxial cable itself, the device then moved into engagement with the hex nut. This device suffers the same drawbacks as those discussed above.

U.S. Pat. No. 7,147,509 to Burris et al. discloses a coaxial connector torque aid, in the form of a generally cylindrical member which is hollow and has the coaxial cable fed therethrough until the device is placed over the hex nut. A machine then permanently affixes the device to the coaxial cable and nut. Of course, while this might be helpful to those purchasing such coaxial cables having the device already permanently attached thereto, it does not assist those who already have coaxial cables interconnected between electronic devices. This is due to the fact that Burris does not provide any slots for receiving the hex nut directly therein.

Accordingly, there is a continuing need for a thumbscrew adapter for F-connectors so as to facilitate the connection between the F-connector and the female plug of the electrical device. The present invention fulfills these needs and provides other related advantages.

### SUMMARY OF THE INVENTION

The present invention is directed to a thumbscrew socket operable for connecting a male F-type coaxial cable connector having an interior threaded hexagonal nut ring rotatably mounted on a leading end thereof to an exterior threaded female F-type connector. As will be more fully described herein, the thumb socket of the present invention is configured and designed to be received directly onto the hexagonal nut in a sideways fashion, and can be selectively removed therefrom.

The thumb socket generally comprises a body comprised of a resiliently flexible material. Typically, the body is multi-faceted, such as having a generally hexagonal configuration to substantially match that of the coaxial cable nut. An exterior wall of the body typically has five facets. A plurality of extended points is in spaced relation on the exterior wall. Typically, these points extend outwardly at the junction of the facets. The extended points form finger holds therebetween.

The body includes an inner wall defining a central cavity having a shape complimentary to at least a portion of an exterior of the coaxial cable nut. Typically, the inner wall of the body includes five facets configured to engage five facets of the coaxial cable nut.

Typically, the body includes a first generally planar end wall. The body also includes a second generally planar end wall which is generally parallel to the first end wall. In a particularly preferred embodiment, the width of the body between the first and second end walls is substantially the width of the coaxial cable nut.

A notch is formed in the body which has a diameter less than a diameter of the coaxial cable nut, but sufficiently large such that the coaxial cable nut can be forcibly received within the central cavity of the body. In a particularly preferred embodiment, a first leg extends away from a first end of the notch at an angle. Similarly, a second leg extends away from a second end of the notch at an angle. Typically, the first and second legs extend outwardly from the notch at an angle substantially matching exterior angles of side facets of the coaxial cable nut. The first and second legs cooperatively facilitate placement of the body on the coaxial cable nut, and also assist in insertion of the coaxial cable nut into the body cavity. This occurs when the thumb socket of the present invention is placed onto the side of the nut, and a downward or sideways force is applied thereto such that the body flexes outwardly somewhat, and receives the hex nut therein, in a clip-like fashion. Manual torque of the body, via the finger holds, can be applied to loosen or tighten the coaxial cable nut.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of a thumb socket for a multi-faceted coaxial cable nut, embodying the present invention;

FIG. 2 is a perspective environmental view, illustrating a male coaxial cable connector and a female connector, a thumb socket of the present invention being disposed above a coaxial cable nut thereof;

FIG. 3 is a perspective diagrammatic view illustrating the placement of a thumb socket onto the coaxial cable nut, in accordance with the present invention;

FIG. 4 is a cross-sectional view illustrating placement of the thumb socket onto the coaxial cable nut;

FIG. 5 is a perspective view illustrating the thumb socket snap-fit and clipped onto the coaxial cable nut;

FIG. 6 is a perspective view illustrating the thumb socket of the present invention attached to the coaxial cable nut;

FIG. 7 is a cross-sectional view taken generally along line 7-7 of FIG. 6; and

FIG. 8 is a cross-sectional and diagrammatic view illustrating turning of the thumb socket and coaxial cable nut, in accordance with the present invention.

### DETAILED DESCRIPTION OF THE PREFERRED EMBODIMENT

As shown in the accompanying drawings, for purposes of illustration, the present invention relates to a thumb socket, generally referred to by the reference number 10, which is designed and configured to snap onto or clip onto a standard F-connector, sometimes referred to as an audio visual (AV) connection, TV cable in, or RF connector. As will be more fully described herein, the thumb socket 10 is configured and designed to facilitate the tightening or loosening of a coaxial cable nut of such an F-connector by hand.

With reference now to FIG. 2, a coaxial cable 100 is shown having an F-type connector 102 at an end thereof. More particularly, a ballast section 104 is disposed between the actual coaxial cable 100 and the male connector, which includes a hexagonal coaxial cable nut 106. As is well known in the industry, the coaxial cable nut 106 includes interior threads, or is connected to a rotatable ring which has internal threads. Moreover, a metal prong (not shown) extends outwardly from the connector 102 for conveying the audio video signal from the electronic device to the coaxial cable 100. A female plug 108 includes an aperture 110 for receiving the metal prong therein. Moreover, the female plug includes a section having exterior threads 112 onto which the hex nut or locatable ring 106 is threaded to secure the connection between the coaxial cable 110 and the female plug 108 of the electronic device.

As can be seen in FIGS. 2 and 3, the coaxial cable nut 106 is multi-faceted, typically having six sides or being hexagonal in configuration. As described above, it can be difficult to manually tighten and loosen the coaxial cable nut 106 to the female plug 108. Although the coaxial cable nut 106 is multi-faceted, it is relatively small and does not provide any finger holds or extended points or wings to which apply manual torque by one's fingers. This is particularly difficult when the user is attempting to tighten or loosen the coaxial cable nut 106 without seeing the coaxial cable nut 106, such as when reaching behind a television or other piece of audio visual equipment.

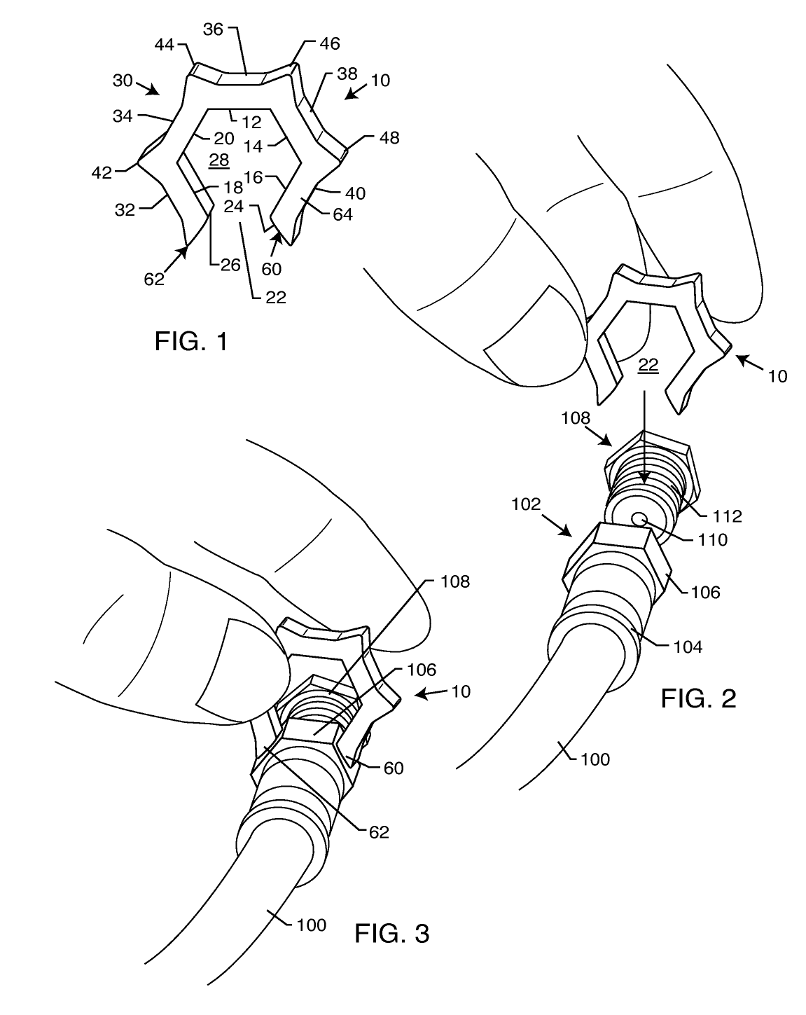

With reference again to FIG. 1, the present invention resides in a thumb socket 10 comprising a body of a resiliently flexible material. The material comprising the body should be sufficiently rigid so that the thumb socket 10 can have force applied thereto to turn it clockwise or counter-clockwise, and be left on the coaxial cable nut 106 as a semi-permanent feature. However, as will be more fully described herein, the material needs to be sufficiently resiliently flexible so as to have spring-like characteristics so as to be snap-fit onto the coaxial cable nut 106 directly from a side thereof.

The international standard for a typical F-connector for a coaxial cable is that the coaxial cable nut 106 be hexagonal in shape. As such, the thumb socket 10 of the present invention is generally hexagonal in configuration. The thumb socket 10 includes an inner wall comprised of facets 12, 14, 16, 18 and 20. These five facets comprise the five sides of a hexagon. A void notch 22 is formed between end points 24 and 26. The notch 22 is slightly less in diameter than the diameter of the coaxial cable nut 106 when the thumb socket 10 is in its relaxed state. The inner wall facets 12-20 and the notch 22 define a void 28 within the body which has a configuration substantially matching that of the exterior of the coaxial cable nut 106, as illustrated in FIG. 7.

The body of the thumb socket 10 has an exterior wall 30 which is multi-faceted. Typically, the exterior wall 30 comprises five facets 32-40. Points 42-48 extend outwardly from the exterior wall 30, typically at the junction between the facets 32-40.

With reference to FIG. 7, the extended points 42-48, typically four radially spaced apart on the outer wall 30 each include slopes 50 and 52 which are sufficiently elongated such that a finger or thumb of the individual can be pressed thereagainst. Thus, finger holds 54, 56 and 58 are formed between the extended points 42-48, which are of sufficient size such that the individual can place his or her fingertip or thumb tip therein and press against a sloped surface 50 or 52 of the extended points 42-48 so as to turn the body of the thumb socket 10.

With reference again to FIG. 1, a leg 60 extends away from a first end 24 of the notch 22 at an angle. Similarly, a leg 62 extends away at an angle from the second end 26 of the notch 22. The legs 60 and 62 extend outwardly from the notch 22 at an angle substantially matching exterior angles of side facets of the coaxial cable nut 106, as illustrated in FIG. 3. As will be more fully explained herein, the first and second legs 60 and 62 cooperatively facilitate placement of the thumb socket body 10 on the coaxial cable nut 106 and insertion of the coaxial cable nut 106 into the body cavity 28.

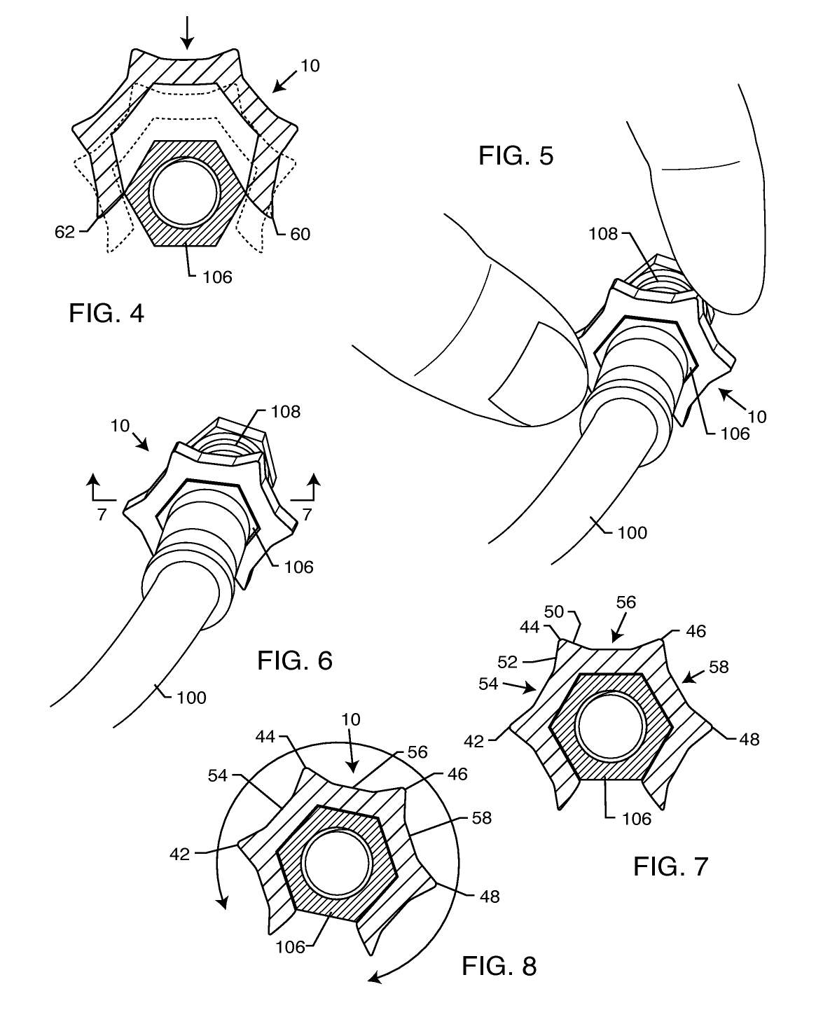

With reference to FIGS. 2-5, in use, the thumb socket body 10 is placed such that the notch 22 is aligned with a facet of the coaxial cable nut 106, as illustrated in FIG. 2. The body 10 is then put into engagement with the coaxial cable nut 106, as illustrated in FIG. 3, such that the legs 60 and 62 come into contact with facets of the coaxial cable nut 106. A downward, or sideways, force is then applied to the thumb socket body, as illustrated in FIG. 4, forcing the legs 60 and 62, and the body itself, to flex outwardly so as to be snap-fit or clipped onto the hex nut 106, as illustrated in FIGS. 5-7. This spring-like snap-fit creates a firm attachment between the thumb socket body 10 and the coaxial cable hex nut 106, as illustrated in FIG. 7. The facets 12-20 of the inner wall of the body 10 engage five facets of the coaxial hex nut 106, as illustrated in FIG. 7.

In a particularly preferred embodiment, the thumb socket body 10 comprises a relatively thin dial face, so as to substantially match the width of the facets of the hex nut 106. As such, the body 10 includes a first generally planar end wall 64, and a second generally planar end wall (not shown) which is generally parallel to the first end wall 64. This allows the thumb socket 10 of the present invention to be relatively small, so as to fit into small spaces where the female plug 108 of the electronic device typically resides. Moreover, the thumb socket 10 of the present invention can be left retained and attached to the coaxial cable nut 106 after an initial use, such as tightening the hex nut 106 and coaxial cable 100 to the female plug 108. This enables the user to easily loosen and remove the coaxial cable 100 and hex nut 106 at a future date, if necessary. Alternatively, the thumb socket body 10 may be removed after use for use on another audio visual cable or for storage purposes.

With reference to FIG. 8, a cross-sectional view of the thumb socket body 10 is shown in engagement with and in snap-fit attachment to the hexagonal coaxial cable nut 106. The aforementioned finger holds 54, 56 and 58 can be used to rotate the thumb socket 10, and thus the attached coaxial cable nut 106 in either a clockwise or counter-clockwise direction. The extended points 42, 44, 46 and 48 serve as a dial and allow manual torque, via the finger holds of the body, to loosen or tighten the coaxial cable nut 106. Once again, after loosening or tightening the coaxial cable nut 106 to the female plug 108, the thumb socket 10 of the present invention may be left in clipped and attached relationship to the coaxial cable nut 106, or removed therefrom.

Although several embodiments have been described in detail for purposes of illustration, various modifications may be made without departing from the scope and spirit of the invention. Accordingly, the invention is not to be limited, except as by the appended claims.

What is claimed is:

1. A thumb socket for a multi-faceted coaxial cable nut, comprising:
a body comprised of a resiliently flexible material, an exterior wall of the body including a plurality of points extending outwardly therefrom in spaced radial relation so as to form finger holds therebetween, the body including an inner wall defining a central cavity having a shape complimentary to at least a portion of an exterior of the coaxial cable nut, a notch formed in the body having a diameter less than a diameter of the coaxial cable nut so as to forcibly receive the coaxial cable nut within the central cavity of the body to permit manual torque via the finger holds of the body to loosen or tighten the coaxial cable nut.

2. The thumb socket of claim 1, wherein the coaxial cable nut is generally hexagonal in configuration.

3. The thumb socket of claim 2, wherein the body is of a multi-faceted configuration.

4. The thumb socket of claim 3, wherein the exterior wall of the body includes five facets and four points extending outwardly between the facets.

5. The thumb socket of claim 3, wherein the interior wall of the body includes five facets configured to engage five facets of the coaxial cable nut.

6. The thumb socket of claim 1, including a first leg extending away from a first end of the notch at an angle, and a second leg extending away from a second end of the notch at an angle, the first and second legs cooperatively facilitating placement of the body on the coaxial cable nut, and insertion of the coaxial cable nut into the body cavity.

7. The thumb socket of claim 6, wherein the first and second legs extend outwardly from the notch at an angle substantially matching exterior angles of side facets of the coaxial cable nut.

8. The thumb socket of claim 1, wherein the body includes a first generally planar end wall.

9. The thumb socket of claim 8, wherein the body includes a second generally planar end wall generally parallel to the first end wall.

10. The thumb socket of claim 1, wherein the body is selectively attached to and removed from the coaxial cable nut.

11. The thumb socket of claim 9, wherein a width of the body between the first and second end walls is substantially the width of the coaxial cable nut.

12. A thumb socket for a multi-faceted F-type coaxial cable nut, comprising:
a multi-faceted body comprised of a resiliently flexible material adapted to be removably attached to the coaxial cable nut, an exterior wall of the body defining a plurality of extended points between adjacent facets of the exterior wall so as to form finger holds therebetween, the body including an inner wall defining a central cavity having a shape complimentary to at least a portion of an exterior of the coaxial cable nut, a notch formed in the body having a diameter less than a diameter of the coaxial cable nut, a first leg extending away from a first end of the notch at an angle substantially matching an angle of a first facet of the coaxial cable nut, and a second leg extending away from a second end of the notch at an angle substantially matching an angle of a second facet of the coaxial cable nut, the first and second legs cooperatively facilitating placement of the body on the coaxial cable nut, and forcible insertion of the coaxial cable nut into the body cavity, to permit manual torque via the finger holds of the body to loosen or tighten the coaxial cable nut.

13. The thumb socket of claim 12, wherein the body is of a generally hexagonal configuration.

14. The thumb socket of claim 13, wherein the exterior and interior walls of the body each include five facets.

15. The thumb socket of claim 12, wherein the body includes a first generally planar end wall and a second generally planar end wall generally parallel to the first end wall.

16. The thumb socket of claim 15, wherein a width of the body between the first and second end walls is substantially the width of the coaxial cable nut.

17. A thumb socket operable for connecting a male F-type coaxial cable connector having an interior threaded hexagonal nut ring rotatably mounted on a leading end thereof to an exterior threaded female F-type connector, the thumb socket comprising:
a body comprised of a resiliently flexible material adapted to be removably attached to the coaxial cable nut, an exterior wall of the body defining five facets, a plurality of extended points between adjacent facets of the exterior wall so as to form finger holds therebetween, the body including an inner wall having five facets defining a central cavity having a shape complimentary to at least a portion of an exterior of the coaxial cable nut such that the inner wall facets engage five facets of the hexagonal coaxial cable nut, a notch formed in the body having a diameter less than a diameter of the coaxial cable nut, a first leg extending away from a first end of the notch at an angle substantially matching an angle of a first facet of the coaxial cable nut, and a second leg extending away from a second end of the notch at an angle substantially matching an angle of a second facet of the coaxial cable nut, the first and second legs cooperatively facilitating placement of the body on the first and second facets of the coaxial cable nut, whereby downward force on the body expands the notch permitting insertion of the coaxial cable nut into the body cavity, and whereby manual torque via the finger holds of the body permits loosening or tightening of the coaxial cable nut to the female connector.

18. The thumb socket of claim 17, wherein the body includes a first generally planar end wall and a second generally planar end wall generally parallel to the first end wall.

19. The thumb socket of claim 17, wherein a width of the body between the first and second end walls is substantially the width of the coaxial cable nut.
